(19) United States
(12) Patent Application Publication
(10) Pub. No.: US 2012/0044137 A1
(43) Pub. Date: Feb. 23, 2012

(54) SCREEN CAPTURE

(76) Inventors: Chandar Kumar Oddiraju, Santa Clara, CA (US); Ramya Venkataramu, Campbell, CA (US); Marguerite Letulle, San Mateo, CA (US)

(21) Appl. No.: 13/257,982

(22) PCT Filed: Apr. 1, 2009
(86) PCT No.: PCT/US09/39221

§ 371 Date: Sep. 21, 2011

(51) Int. Cl. G06T 1/60; G06T 1/00; G06F 3/01

(52) U.S. Cl. 345/156; 345/530; 345/501

(57) ABSTRACT

A screen capture system (46, 346) stores in a memory (40, 340) at least portions of screenshots of output (50) presented on a display screen (36, 336) by a source (30, 330) and presents the stored screenshots on the display screen (36, 336) when the source (30, 330) is not running.

### BACKGROUND

In many instances, a person may desire to quickly retrieve small pieces of information, such as calendar appointments, a meeting agenda, documents or the like from a computer or other source. To retrieve the information, the source of the information is typically powered on and navigated. For example, to obtain information from a computer source, the person will typically (1) boot up the computer, (2) navigate to the program or application and (3) open and run the application. As a result, such retrieval of information may be tedious and time-consuming.

### BRIEF DESCRIPTION OF THE DRAWINGS

FIG. 1 is a schematic illustration of a display system according to an example embodiment.

FIG. 2 is a flow diagram of a method for storing and displaying a information according to an example embodiment.

FIG. 3 is a schematic illustration of another embodiment of the display system of FIG. 1 according to an example embodiment.

FIG. 4 is a schematic illustration of another embodiment of the display system of FIG. 1 according to an example embodiment.

FIG. 5 is a schematic illustration of another embodiment of the display system of FIG. 1 according to an example embodiment.

FIG. 6 is a schematic illustration of another embodiment of the display system of FIG. 1 according to an example of embodiment.

FIG. 7 is a flow diagram of another method for storing and displaying information according to an example embodiment.

### DETAILED DESCRIPTION OF THE EXAMPLE EMBODIMENTS

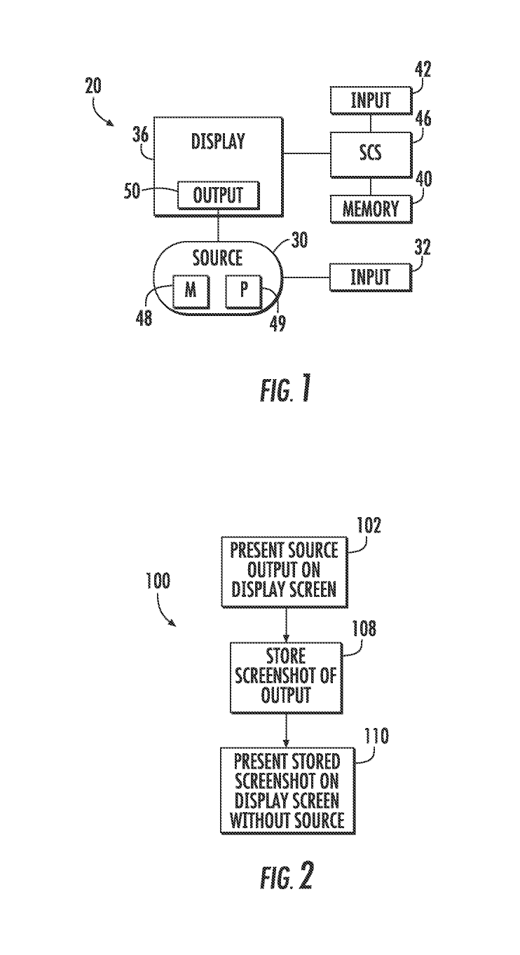

FIG. 1 is a schematic illustration of a display system 20 according to an example embodiment. As will be described hereafter, display system 20 enables a person to easily retrieve small pieces of information. Display system 20 includes source 30, input 32, display screen 36, memory 40, input 42 and screen capture system 46.

Source 30 comprises a source of images, including static and video images, text, data or other information (hereinafter referred to as “output”) to be presented, depicted or displayed on display screen 36. In one embodiment, source 30 comprises a computer operating system and one or more applications. For purposes of this disclosure, a computer operating system comprises software configured to serve as an interface between the applications and any hardware of system 20. Hardware may comprise any physical structures of display system 20. Examples of hardware include, but are not limited to, a motherboard, a central processing unit (CPU) chip, a memory, a monitor, a printer, a scanner, input 32, display screen 36 and the like. The applications comprise software which runs on top of the operating system. The operating system acts as a host for the applications that run on the display system 20. Serving as a host, the operating system handles the details of the operation of the hardware for the applications. In one embodiment, the operating system offers services to such applications or application programs through system calls or application programming interfaces. Such an operating system may comprise a multi-user operating system, a multiprocessing operating system, a multitasking operating system, a multithreading operating system and a real-time operating system. Specific examples of contemporary operating systems include Microsoft Windows, Mac OS, Linux, Unix, BSD, Solaris, Plan 9, and various embedded systems. In yet another embodiment, source 30 may comprise other sources such as a source of a broadcast television display.

In one embodiment, source 30 is at least partially embodied as a memory 48 and a processor 49. Memory 48 comprises one or more persistent storage devices configured to store the computer operating system. Examples of such a memory include a hard disc drive.

Processor 49 comprises one or more processing units configured to generate control signals according to the operating system stored on the memory 49. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Unless otherwise specifically noted, the controller is not limited to any specific combination of hardware circuitry and software, nor to any particular source for the instructions executed by the processing unit. In other embodiment, source 30 may have other configurations.

Input 12 comprises one or more mechanisms or devices by which a person may turn on or initiate the operation of source 30 and by which a person may provide or enter instructions or commands to source 30 for directing the operation of source 30 or for facilitating interface with source 30. In some embodiments, input 32 may further facilitate the entry, loading or input of images, data or other information to source 30 for storage on a memory associated with source 30 or for use by source 30. Examples of input 32 include, but are not limited to, keyboards, touch pads, touch screens, a mouse, push buttons, slider bars, toggle switches and a microphone with speech recognition application. In one embodiment, input 32 may be provided as part of display screen 36, such as when display screen 36 comprises a touch screen. In one embodiment, input 32 comprises a push button serving as a power on/off button, wherein depressment of the pushbutton turns on source 30 and initiates the operation of source 30. For example, in one embodiment, depressment of the push button boots up the operating system of source 30.

Display screen 36 comprises a panel or screen configured to visually present output 50 (schematically illustrated) from source 30 as well as to visually present at least portions of output 50 supplied by screen capture system 46 when source 30 is not operating or running. Display screen 36 may have a variety of different sizes, shapes and configurations. For example, display screen 36 may be a screen which is part of a monitor of a desktop computer, part of a laptop computer, part of a handheld computer, part of a personal data assistant (PDA), part of a personal entertainment system or music player, part of a video game system console or monitor, or part of a larger computer system.

Memory 40 comprises one or more persistent storage devices connected to screen capture system 46 and configured to store screenshots (including smaller portions thereof) of output 50 captured by screen capture system 46. In one embodiment, memory 40 is distinct and independent from any memory accessed by source 30. In one embodiment, memory 40 is fixedly associated with screen capture system 46 such that memory 40 is inseparable from screen capture system 46. In another embodiment, memory 40 may be portable and separable from screen capture system 46. For example, in one embodiment, memory 40 may comprise a flash memory card configured to be removably inserted into a memory card read/write slot associated with screen capture system 46. In yet another embodiment, memory 40 may be configured to be also accessed and used by source 30 when source 30 is operating.

Input 42 comprises one or more mechanisms or devices by which a person may turn on or initiate the operation of screen capture system 46 directing the operation of screen capture system 46 or facilitating interface with screen capture system 46. Examples of input 42 include, but are not limited to, keyboards, touch pads, touch screens, a mouse, push buttons, slider bars, toggle switches and a microphone with speech recognition application. In one embodiment, input 42 may be provided as part of display screen 36, such as when display screen 36 comprises a touch screen.

In one embodiment, input 42 comprises a pushbutton serving as a screen shot capture button when source 30 is operating and serving as a display button when source 30 is not running or not operating. In yet other embodiments, input 42 may comprise different push buttons or different input devices for (1) capturing screenshots and (2) retrieving and displaying a previously captured and stored screenshot.

Screen capture system 46 comprises a system configured to store in memory 40 at least portions of screen shots of output 50 presented on display screen 36 by source 30 when source 30 is running. Screen capture system 46 is also configured to later present the stored screenshots of output 50 on display screen 36 when source 30 is not operating or not running. For purposes of this disclosure, the term “screen capture system” shall mean any hardware, software, computer readable medium, computer program, or integrated circuit configured to store in a memory at least portions of screen shots of output presented on display screen by a source when source 30 is running and to also later present the stored screenshots of output on the display screen when the source is not operating, is not powered or is otherwise not running. For purposes of this disclosure, a “screen shot”, also known as a screen capture or screen dump, is an image taken or captured by screen capture system 46 to record the visible items displayed on display screen 36 (output 50). In one embodiment, the screenshot may comprise the entire screen in a bitmap image format such as bitmap (BMP), device independent bitmap (DIB), portable network graphics (PNG) or Joint Photograph Experts Group (PEG). In another embodiment, the screenshot may comprise what is being used internally to form output 50 such as SWD X Window Dump image data in the case of the X Window System (X11) or PNG in the case of Mac OS X. In one embodiment, a screen capture may comprise capturing of the screen over an extended period of time to form a video file.

According to one embodiment, screen capture system 46 includes electronic hardware. In other words, screen capture system 46 may be embodied by electronic circuitry, such as an application specific integrated circuit (ASIC) without any reliance upon software applications for its operation. Screen capture system 46 is configured to operate independent of source 30 when screen captures system 46 is displaying the stored screenshots on display 36. In one embodiment, screen capture system 46 is embodied with display screen 36. In another embodiment, screen capture system 46 is embodied with source 30 or input 32. Regardless of where screen capture system 46 is embodied, screen capture system 46 may be run or operated while source 30 is not running.

The ability of screen capture system 46 to capture and store screenshots provided by source 30 and to later display such stored screenshots while source 30 is not running enables a person to more quickly retrieve and access information or output 50 that was previously displayed by source 30. In particular, output 50, in the form of one of more screenshots, may be retrieved without a person having to turn on source 30 or navigate source 30. For example, a person may retrieve output 50 without having to boot up the operating system of source 30, without having to navigate to the one or more software applications of source 30 and without having to run the one or more software applications.

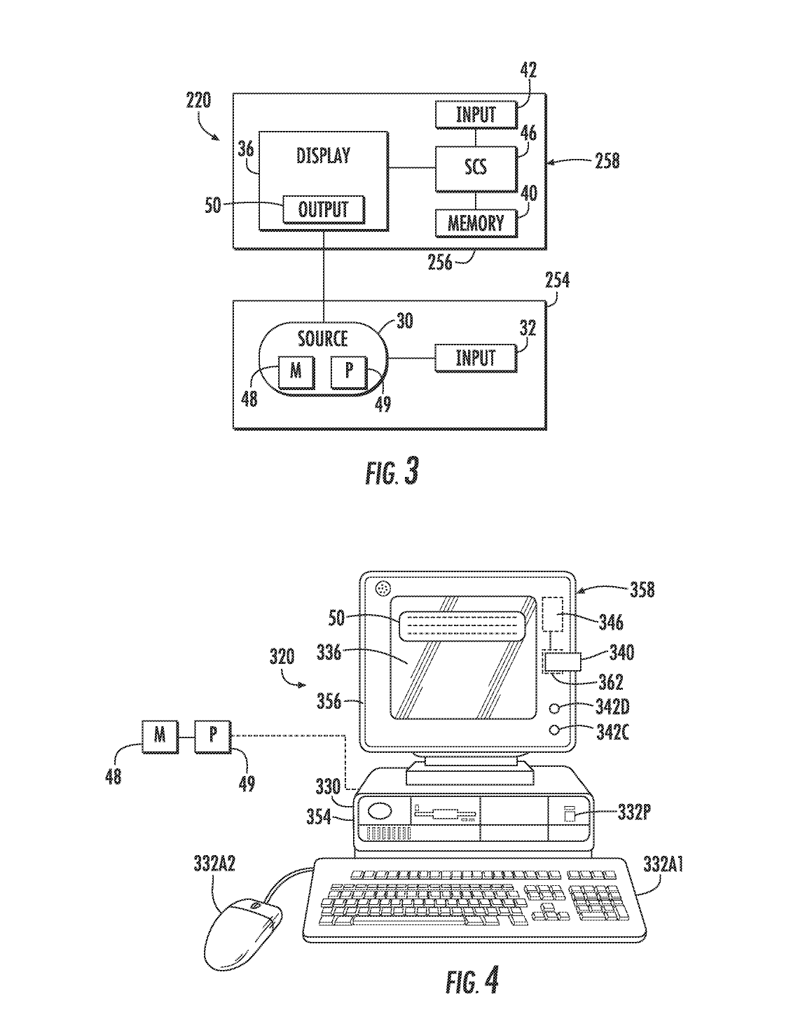

FIG. 2 is a flow diagram illustrating one example method 100 which may be carried out by display system 20. As indicated by step 102, source 30 presents output 50 on display screen 36. In one embodiment, the presentation of output 50 on display 36 by source 30 may be the result of a person booting up operating system of source 30 and running one or more software applications of source 30. The operating system of source 30 interfaces between the one or more software applications and display screen 36.

As indicated by step 108, screen capture system 46 stores a screen shot of output 50 in memory 40. In one embodiment, screen shot capture system 46 captures whatever is displayed on display screen 36 (output 50) at the time that input 42 is actuated (e.g. the time at which a pushbutton is depressed). Screen shot capture system 46 then automatically stores the captured screenshot in memory 40 for later retrieval.

In another embodiment, screen shot capture system 46 captures whatever is displayed on display screen 36 (output 50) at the time that input 42 is actuated (e.g. the moment at which a pushbutton is depressed). However, prior to storing the screenshot, screenshot capture system 46 displays the captured screenshot of output 50 on the display screen 36 with a confirmation request before storing the captured screenshot in memory 40. The person may confirm that the displayed captured screenshot is to be stored in memory 40 using input 42 (such as by depressing the pushbutton a second time while the captured screenshot of output 50 is displayed on display screen 36). In response to the second actuation of input 42 (whether it be the same pushbutton or a different element of input 42 that is actuated), screen capture system 46 then stores the captured screenshot in memory 40. In such an embodiment, the person is permitted to visually see the captured screenshot prior to its storage in memory 40 to ensure that the captured screenshot contains a particular output 50 that the person wishes to capture and later retrieve. In some embodiments, this confirmation step may be omitted to reduce complexity.

As indicated by step 110, screen capture system 46 presents the stored screenshot of output 50 on display screen 36 at a later time without source 30 (without source 30 operating or running). In one embodiment in which display system 20 includes a computer as source 30, screen capture system 46 presents the retrieved captured screenshot on display screen 36 while the computer is not running or shutdown (the operating system is not running).

According to one embodiment, screen capture system 46 retrieves and displays the previously captured screenshot of output 50 on display screen 36 in response to actuation of input 42 while source 30 is not running. For example, depressment of a pushbutton of input 42 while source 30 is not operating causes or results in screen capture system 46 accessing the most recent captured screenshot stored in memory 40 and displaying the captured screenshot on display screen 36. In one embodiment, actuation of the same element (such as a pushbutton) of input 42 initiates both the capture of a screenshot and the display of a captured and stored screenshot depending upon the state of source 30, i.e. whether source 30 is turned on or off. In yet another embodiment, actuation of the same element (such as a pushbutton of input 42 initiates either the capture of a screenshot or the display of a captured and stored screenshot depending upon how long or the amount of time that the input 42 is actuated (such as how long the push button is depressed).

In another embodiment, separate and independent elements of input 42 may be used to initiate the capture of a screenshot of output 50 and to display a previously stored screenshot. For example, a first button may be used to initiate the capture of a screenshot while a second button may be used to display a stored screenshot. In one embodiment, screen capture system 46 may also be configured to display stored screenshots even when source 30 is running or operating.

In one embodiment, screen capture system 46 may be configured such that successive actuations of the element of input 42 used to initiate the display of a stored screenshot causes screen capture system 46 to scroll through previously stored screenshots in sequence starting with the newest stored screenshot and ending with the oldest stored screenshot. In yet other embodiments, screen capture system 46 may be configured so as display an index or thumbnails of multiple stored screenshots response to actuation of an element of input 42, whereby a person may select one of the indexed screenshots or thumbnails for full display on display screen 36 using an element of input 42.

FIG. 3 schematically illustrates display system 220, a particular embodiment of display system 20. Like display system 20, display system 220 includes source 30, input 32, display screen 36, memory 40, input 42 and screen capture system 46. As shown by FIG. 3, display system 220 additionally includes housings 254 and 256. Housing 254 supports, encloses and extends about source 30 and input 32. In one embodiment, in which source 30 comprise a computer, housing 254 supports and encloses the hardware and software providing the operating system and applications of source 30. In other embodiments, housing 254 may have a variety of different sizes, shapes and configurations depending upon the form in which display system 220 is embodied.

Housing 256 extends about, supports and contains the hardware which form display screen 36. Housing 256 additionally encloses and extends about screen capture system 46. For example, in one embodiment, housing 256 contains and encloses the electronic circuitry or electronic hardware forming screen capture system 46. In the example illustrated, housing 256 also supports and encloses memory 40 and input 42. As a result, housing 256, in combination with display screen 36, memory 40, input 42 and screen capture system 46, forms a self-contained unit 258. The self-contained unit 258 may be preassembled, stored and inventoried for subsequent connection to source 30 and input 32. For example, in one embodiment, unit 258 may be formed as a laptop computer screen configured to be subsequently attached to a connected to a laptop base including a keyboard.

In yet another embodiment, unit 258 may be self-supported independent of source 30 and input 32, permitting unit 258 to be selectively connected to multiple different sources 30 and input 32. For example, in one embodiment, unit 258 may be configured as a desktop computer monitor which may be selectively connected to any of a variety of desktop computer hard drive systems which include a source 30 (having an operating system and one or more software applications) and input 32 (such as a on/off button or keyboard).

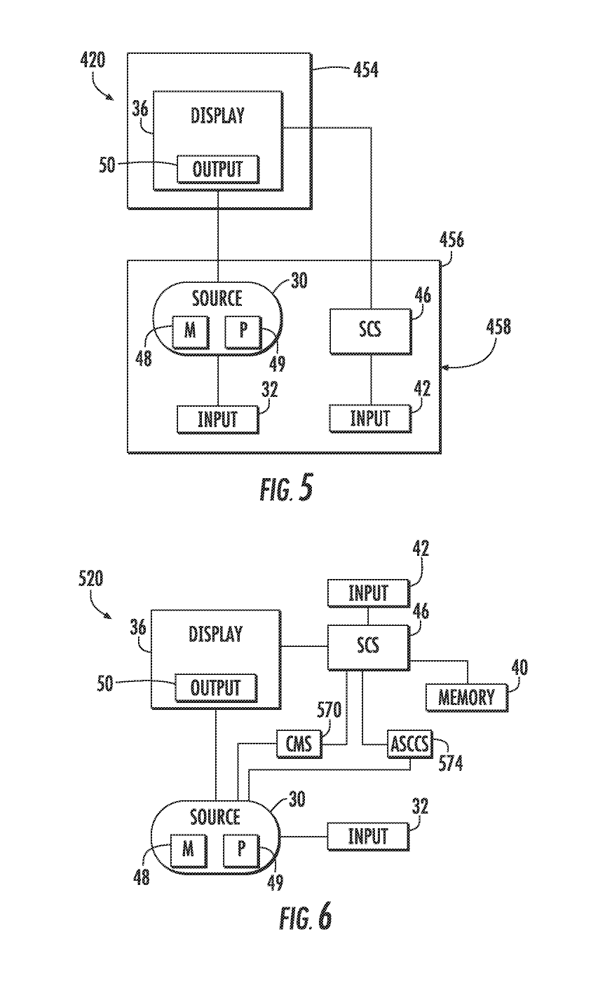

FIG. 4 is a front perspective view of display system 320, a particular embodiment of display system 220. Display system 320 includes source 330, inputs 332P, 332A1, 332A2 (collectively referred to as inputs 332), display screen 336, memory 340, inputs 342C and 342D, screen capture system 346, housing 354 and housing 356. Source 330 is similar to source 30 except that source 330 is specifically embodied as a computer including internal memory (such as a hard drive) upon which an operating system and software applications reside. The operating system of source 330 interfaces between the software applications and the hardware of display system 320 including inputs 332 and display screen 336. Source 330 is enclosed by housing 354.

Inputs 332 facilitate control of source 330. Input 332P comprises an on/off switch or power switch for source 330. Depressment or actuation of input 332P boots up the operating system of source 330. Input 332A1 is a keyboard while input 332A2 is a mouse. Inputs 332A1 and 332A2 facilitate navigation through the operating system and control during the running of the software applications of source 330. As noted above with respect to discussion of input 32, inputs 332 may have a variety of different configurations. Although input 332P is illustrated as being enclosed and supported by housing 354, in other embodiments, input 332P may alternatively be applied as part of input 332A1 or may be provided at other locations.

Display screen 336 is similar to display screen 36 except that display screen 336 is specifically embodied as a screen of a desktop monitor. Memory 340 is similar to memory 40 except that memory 340 is specifically embodied as a removable flash memory card connected to screen capture system 346 by being received within a flash memory card slot 362 extending into housing 356. Because memory 340 is removable, memory 340, and the screen shots stored on memory 340, are portable and may be transported and displayed on other display screens having screen capture system 46, screen capture system 346 or appropriate software or viewing utilities. In other embodiments, memory 340 may comprise other forms of memory and may be largely inaccessible and not removable from within housing 356.

Input 342C comprises an input element for controlling screen capture system 346 to initiate the capture and storage of a screenshot of output 50 being presented on display screen 336 by source 330 at a particular moment in time. In the example illustrated, input 342C comprises a pushbutton configured such that depressment causes screen capture system 346 to capture a screenshot.

Input 342D comprises an input element for controlling screen capture system 346 to initiate the display of a previously stored screenshot of output 50 on display screen 336. In the example illustrated, input 342C comprises a pushbutton configured such that depressment causes screen capture system 346 to present or display a previously stored screenshot display screen 336.

Screen capture system 346 is substantially similar to screen capture system 46. In the example illustrated, screen capture system 346 is embodied or consists of electronic hardware or circuitry, not relying on any software applications which would utilize an operating system of source 330. As a result, screen capture system 346 may be operated independent of source 330 and independent of the operating system of source 30. Consequently, screen capture system 346 may present previously stored screenshots of output 50 on display screen 336 while source 330 is shut down or not operating.

As with system 220, system 320 has a housing 356 that extends about, supports and contains the hardware which form display screen 36. Housing 356 additionally encloses and extends about screen capture system 346. For example, in one embodiment, housing 356 contains and encloses the electronic circuitry or electronic hardware forming screen capture system 346. In the example illustrated, housing 356 also supports and encloses memory 340 and inputs 342. As a result, housing 356, in combination with display screen 336, memory 340, inputs 342 and screen capture system 346, forms a self-contained unit or display monitor 358 that is self-supported independent of source 330 and input 332, permitting monitor 358 to be selectively connected to multiple different sources 330 and input 332. For example, in one embodiment, monitor 358 may be selectively connected to any of a variety of desktop computer hard drive systems which include a source 330 (having an operating system and one or more software applications) and inputs 332 (such as a on/off button or keyboard). Monitor 358 may also be connected to other sources such as a television, video game console, cable box or satellite box.

FIG. 5 schematically illustrates display system 420, another embodiment of display system 20. Like display system 20, display system 420 includes source 30, input 32, display screen 36, memory 40, input 42 and screen capture system 46. As shown by FIG. 5, display system 420 additionally includes housings 454 and 456. Housing 454 supports, encloses and extends about display screen 36. Housing 454 encloses and contains the hardware which form display screen 36.

Housing 456 supports and encloses the hardware and software providing the operating system and applications of source 30. Housing 456 additionally encloses and extends about screen capture system 46. For example, in one embodiment, housing 456 contains and encloses the electronic circuitry or electronic hardware forming screen capture system 46. In the example illustrated, housing 456 also supports and encloses memory 40 and input 42. As a result, housing 456, in combination with source 30, input 32, input 42, and screen capture system 46, form a self-contained unit 458. The self-contained unit 458 may be preassembled, stored and inventoried for subsequent connection to display screen 36. For example, in one embodiment, unit 458 may be formed as a laptop base configured to be subsequently attached or a connected to a laptop display screen. In other embodiments, housing 456 may have a variety of different sizes, shapes and configurations depending upon the form in which display system 420 is embodied.

In yet another embodiment, unit 458 may be self-supported independent of display screen 36, permitting unit 458 to be selectively connected to multiple monitors including display screen 36. For example, in one embodiment, unit 458 may be configured as a desktop computer hard drive system which may be selectively connected to any of a variety of desktop monitors.

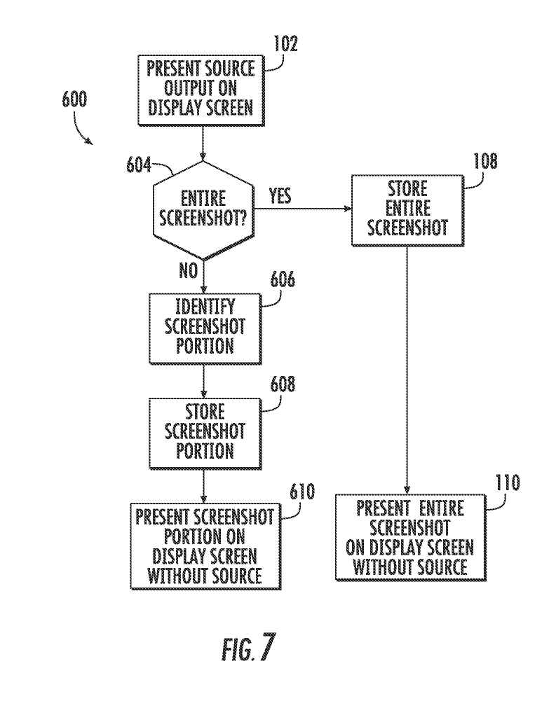

FIG. 6 schematically illustrates display system 520, another embodiment of display system 20. Display system 520 is similar to display system 20 except that display system 520 additionally includes capture modification system 570 and automatic screen capture control system 574. The remaining elements or components of display system 520 which correspond to components or elements of system 20 are numbered similarly.

Capture modification system 570 comprises a software application or program, or hardwired circuitry, configured to enable screen capture system 46 to capture and store less than complete or less than whole portions of a screen shot of output 50. In other words, capture modification system 570 enable screen capture system 46 to capture and store less than all of what is displayed at any moment in time on display screen 36. In one embodiment, capture modification system 570 comprises an extension of screen capture system 46 in the form of software which is run while source 30 is operating.

For example, in one embodiment, upon appropriate actuation of one more elements of input 32 by person, the operating system of source 30 prompts the person to identify what particular portion or area of what is being presented on display screen 36 (output 50) is to be captured by screen capture system 46. The person may identify the selected portion to be captured using a mouse, a keypad, a touch screen, a touchpad or any other elements of input 32. Once a selection is made, capture modification system 570 and source 30, working together, transmit the selected area to screen capture system 46 for capture and storage.

FIG. 7 is a flow diagram of a method 600 illustrating one example method 600 which may be carried out by display system 520. Method 600 is similar to method 100 shown and described with respect to FIG. 2 except that method 600 includes additional steps facilitating the option of capturing and storing less than entire screenshots. For sake of brevity, those steps of method 600 which correspond to steps of method 100 are numbered similarly.

As indicated by step 102, source 30 presents output 50 on display screen 36. In one embodiment, the presentation of output 50 on display 36 by source 30 may be the result of a person booting up operating system of source 30 and running one or more software applications of source 30. The operating system of source 30 interfaces between the one or more software applications and display screen 36.

As indicated by step 604, upon an indication by a person requesting the capturing of a screenshot, capture modification system 570 prompts the person to indicate whether he or she wishes to capture the entire screen shot, the entirety of what is presently being displayed on display screen 36. The person may respond using one of more elements of input 32. As shown by FIG. 7, if the person responds by indicating that indeed the entire screenshot is to be captured and stored (a “yes”), steps 108 and 110 are carried out. In particular, the entirety of the screenshot is captured and stored in memory 40 as indicated by step 108. As indicated by step 110, upon subsequently receiving a command or request via input 42 for display of the captured screenshot, screen capture system 46 presents or displays the entire stored screenshot on display screen 36 without source 30 operating. In one embodiment, screen capture system 46 is also configured to also present or display the entire stored screenshot on display screen 36 while source 30 is operating.

As further indicated by FIG. 7, if the person responds to the prompt of step 604 by indicating that the entirety of the screenshot is not to be stored (only a portion of the screenshot is to be captured and stored) (a “no”), steps 606, 608 and 610 are subsequently performed. As indicated by step 606, capture modification system 570 prompts or requests the person to identify what portion of what is presently being displayed on display screen 36 should be captured and stored or what portion of what is being presented on display screen 36 should not be captured and stored. A person may respond to this prompt by graphically identifying on display screen 36 using input 32 what is to be captured or what is not to be captured. Examples of elements of input 32 that may be used to identify the portion or multiple separate portions of what presently being displayed is to be captured and stored include, but not limited to, a mouse, keyboard, a stylus, touch pad and a touch screen (possibly display screen 36).

As indicated by step 608, screen capture system 46 captures and stores the selected screenshot portion in memory 40. In one embodiment, capture modification system 570 and source 30, working together, transmit the selected area or areas to screen capture system 46 for capture and storage. In another embodiment, capture modification system 570 may alternatively transmit the boundaries of those portions which are to be captured to screen capture system 46.

As indicated by step 610, upon subsequently receiving a command or request via input 42, screen capture system 46 presents or displays the stored screenshot portion on display screen 36 without source 30 operating. In one embodiment, screen capture system 46 is also configured to also present or display the stored screenshot portion on display screen 36 while source 30 is operating.

As with display system 20, screen capture system 46 may retrieve and present or display the stored screen shot portion from memory 40 and display or present the retrieved screen shot portion on display screen 36 without source 30 necessarily operating or running. As a result, retrieval of information is less time-consuming and tedious. Because capture modification system 570 enables only portions of what is being displayed on display screen 36 to be captured and stored as a screenshot, memory space in memory 40 is conserved and more defined nuggets of images or data may be stored and subsequently retrieved, enabling a person to selectively omit irrelevant and unneeded information from what is being stored. In other embodiments, capture modification system 570 may be omitted.

As shown by FIG. 6, like capture modification system 570, automatic screen capture control system 574 modifies the operation of screen capture system 46. Automatic screen capture control system 574 comprises a software application or program, or hardwired circuitry, configured to direct screen capture system 46 to automatically capture and store at least screenshot portions in memory 40 at preselected times or in response to predefined conditions. Instead of screen capture system 46 capturing and storing what is presently being displayed on display screen 36 or portions of what is presently being displayed on display screen 36 in response to actuation of one more elements of input 42 (such as by depressment of a screen capture button 342C shown in FIG. 4), screen capture system 46 automatically captures and stores screenshots under the direction of automatic screen capture control system 574 without repeated manual instructions or human intervention.

For example, in one embodiment, automatic screen capture control system 574 may be configured to direct screen capture system 46 to automatically capture and store a screenshot of what is being displayed on display screen 36 at predetermined time intervals or at predetermined times. Such predetermined time intervals or predetermined determined times may be selected and established as a setting by person using display system 220. For example, in one embodiment, screen shots or predefined portions of screenshots may be automatically captured and stored every 5 seconds or at predefined times (i.e., 1:00 PM, 1:20 PM etc.). Such intervals or predefined times may be set by the person using system 220 so as to vary during the course of the day, week or month, or may be temporarily paused.

In one embodiment, automatic screen capture control system 574 may be further configured to compare content of what is captured with the content of those screenshots already stored on memory 40 before storing the captured screenshot in memory 40. If the newly captured screenshot is the same or is not sufficiently different than an already stored screenshot, the newly captured screenshot may be discarded and not stored or the previously stored screenshot may be over written with the newly captured screenshot.

In another embodiment, automatic screen capture control system 574 may be configured to automatically capture and store a screenshot report of a screenshot of what is presently being displayed on display screen 36 in response to a change in what is being displayed on display screen 36. For example, if a preselected minimum percentage of what is being displayed on display screen 36 changes or if a preselected or predefined data elements being displayed on display screen 36 change, automatic screen capture control system 574 may be configured to detect and evaluate such changes and to direct screen capture system 46 to automatically capture and store a screenshot or portion of a screenshot after each change is detected. In this way, automatic screen capture control system 574 automatically creates a screenshot record or backup that may be quickly and easily retrieved at a later time without source 30 being operated.

Although display system is illustrated as including both capture modification system 570 and automatic screen capture control system 574, in other embodiments, display system 520 may alternatively include one of either capture modification system 570 or automatic screen capture control system 574. As with display system 20, display system 520 may be embodied in any of the constructions shown and described with respect to FIGS. 3-5. In such embodiments, capture modification system 570 and automatic screen capture control system 574 may be contained, enclosed and supported by either housing 254 or housing 256 of display system 220, by either housing 354 or housing 356 of display system 320 or housing 454 or housing 456 of display system 420. In some embodiments, capture modification system 570 and automatic screen capture control system 574 may be housed or contained by separate housings. For example, in one embodiment in which capture modification system 570 comprises a software application or program and wherein automatic screen capture control system 574 consists of hardwired circuitry or an application-specific integrated circuit (ASIC), capture modification system 570 may reside with source 30 while automatic screen capture control system 574 resides with screen capture system 46.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a screen capture system (46, 346) configured to store in a memory (40, 340) at least portions of screenshots of output (50) presented on a display screen (36, 336) by a source (30, 330) and to present the stored screenshots on the display screen (36, 336) when the source (30, 330) is not running.

2. The apparatus of claim 1, wherein the source (30, 330) comprises a computer operating system.

3. The apparatus of claim 2 further comprising:
the first user input (32, 332) for the computer operating system; and
a second user input (42, 342) for the screen capture system (46, 346).

4. The apparatus of claim 3, further comprising:
the display screen (36, 336); and
a housing (256, 356) about the display screen (36, 336), wherein the second user input is supported by the housing (256, 356).

5. The apparatus of claim 3, further comprising a housing (256, 356) about the display screen (36, 336), the housing enclosing the screen capture system (46, 346).

6. The apparatus of claim 5 further comprising a user input (42, 342) for the screen capture system (46, 346), the user input (42, 342) being supported by the housing.

7. The apparatus of claim 1 further comprising:
the computer operating system (30, 330); and
a housing (456) enclosing the screen capture system (46, 346) and the computer operating system (30, 330).

8. The apparatus of claim 1, wherein the screen capture system (46, 346) consists of electronic hardware.

9. The apparatus of claim 1 further comprising a capture modification system (570) configured to transmit a selected portion of an individual screen shot to the screen capture system (46, 346) for storage and subsequent presentation on the display when the source (30, 330) is not running.

10. The apparatus of claim 1 further comprising an automatic screen capture control system (574) configured to direct the screen capture system (46, 346) to automatically capture the at least portions of screenshots at preselected times or in response to preselected conditions.

11. The apparatus of claim 1 further comprising the memory (340), wherein the memory (340) is a removable flash memory card.

12. A method comprising:
presenting output (50) from a source (30, 330) on a display screen (36, 336);
storing at least portions of screenshots of the output (50) in a memory (40, 340); and
presenting the stored screenshots on the display screen (36, 336) when the source (30, 330) is not running.

13. The method of claim 12 wherein the source (30, 330) of the output (50) is a computer operating system and one or more software applications.

14. The method of claim 12, wherein the storing and the presenting are carried out by electronic hardware connected to the display screen (36, 336)

15. A system comprising:
a display screen (36, 336);
at least one processor (49) configured to present output on the display screen (36, 336);
a memory (40, 340); and
a screen capture system (46, 346) configured to store in the memory (40, 340) at least portions of screenshots of output (50) presented on the display screen (36, 336) by the at least on processor and to present the stored screenshots on the display screen (36, 336) when the at least one processor is not running.
